(19) United States
(12) Patent Application Publication
(10) Pub. No.: US 2009/0139581 A1
(43) Pub. Date: Jun. 4, 2009

(54) VENT VALVE

(76) Inventor: Geoffrey Francis Herlihy, Western Australia (AU)

Correspondence Address: GOTTLIEB RACKMAN & REISMAN PC, 270 MADISON AVENUE, 8TH FLOOR, NEW YORK, NY, 10016-0601, US

(21) Appl. No.: 11/911,211

(22) PCT Filed: Apr. 11, 2006
(86) PCT No.: PCT/AU2006/000487

§ 371 Date: Jul. 18, 2008

(30) Foreign Application Priority Data
Apr. 11, 2005 (AU) 2005901767

(51) Int. Cl. F16K 24/04

(52) U.S. Cl. 137/202

(57) ABSTRACT

A pipeline vent valve comprising a body (11) defining a chamber of clerestory configuration in which the upper portion (B) of the chamber is of reduced cross-sectional area, the chamber having an inlet (13) towards its lower end which is adapted to be connected to a pipeline and an outlet (15) in the upper portion, a valve body (23) supported in the upper portion of the chamber to be movable between a first position at which it is in sealing engagement with the outlet and a second position at which it is out of sealing engagement with the valve seat, said valve body being responsive to the level of liquid in the chamber in the chamber and being adapted to close on the liquid level in the chamber exceeding a predetermined level, said valve body having central passage (37) providing communication to each side of the valve body, a float member (21) supported within the chamber and adapted to cause said movement of said valve body between the first and second position as a result of the presence of liquid in the chamber, the float member being further adapted sealingly engage said central passage as the liquid in the chamber reaches the predetermined level and to and expose said passage on relative movement of the float member away from the valve body.

### FIELD OF THE INVENTION

This invention relates to vent valves which are utilised in pipelines for releasing of air and other gases from the pipeline in order to prevent the formation of air pockets at high points along a pipeline which would otherwise restrict the flow of water through the pipeline. In particular the invention relates to those valves which are known as combined air release valves which are designed to vent or admit large quantities of air whilst the pipeline is being filled and emptied and to continuously release small amounts of air which accumulate in the pipeline in use and specifically relates to those valves which are used on extremely contaminated water service such as sewer mains.

### BACKGROUND ART

Several types of air release valves are known. The first type commonly termed an automatic air release valve releases air which is accumulated under-pressure in a pipeline during normal operating conditions. In this type of valve a float member is located within a housing which is mounted at its lower end to a pipeline which is to be vented by the valve body. The housing is provided at its upper end with venting aperture. During normal operation with the flow of water through the pipeline, water enters the housing which buoys the float member upwardly against the outlet aperture to seal the outlet aperture. However, when air migrates' into the housing from the pipeline water is displaced out of the housing causing the float member to be displaced downwardly by gravity thereby opening the outlet aperture and allowing the air to vent. In this type of valve the dimensions of the venting aperture are small as the mass of the float must be greater than the force created by the working pressure which is operating on the orifice area.

A second type of vent valve commonly called combined air release valves employ a second substantially larger float member and a second substantially larger venting orifice to the automatic float member and venting orifice in one common housing. This type of valve allows large quantities of air to be vented from or admitted to the pipeline during filling or draining of the pipeline and also permit the continuous release of air under pressurised conditions. In both forms of construction the larger float member remains in sealing engagement with the venting orifice whilst the valve is pressurised and will only reopen once pressure in the housing has dropped to atmospheric pressure, and as a result the air may only be vented through the small orifice during the pressurised operation.

A disadvantage of vent valves of the form described above is that, when used on sewer mains, in order to prevent foreign matter present in the water fouling the seals, the height of the valve housing is increased significantly in order to provide an air gap between the water level in the housing and the seals when the valve is pressurised rendering these constructions unsuitable for use where height limitation apply which is a common occurrence in underground sewer mains. A further disadvantage is that the outlet seals require a certain amount of internal pressure, normally twenty kilopascals in order to achieve an effective seal. In some cases when the mains are charged full but the pumps are not running the pressure inside the valve housing is not sufficient to effect a seal and the valves leak allowing solid matter in the effluent to become lodged between the sealing faces causing further leakage when the pumps are started. A further problem occurs when the rising slope downstream of a valve is shallow with the result that during filling of a sewer main the vent valves fill very slowly such that when the seals make contact insufficient internal pressure is available allowing air to escape causing effluent to submerge the seals and leak until such time as sufficient hydraulic head has built up to effect a seal, but by then, as above solids become wedged between the sealing faces and the valve continues to leak.

It is an object of the present invention to overcome at least some of the problems referred to above or at least reduce the likelihood of at least some of the difficulties referred to above arising.

### DISCLOSURE OF THE INVENTION

Accordingly, the invention resides in a pipeline vent valve comprising a body defining a chamber of clerestory configuration in which the upper portion of the chamber is of reduced cross-sectional area, the chamber having an inlet towards its lower end which is adapted to be connected to a pipeline and an outlet in the upper portion, a valve body supported in the upper portion of the chamber to be movable between a first position at which it is in sealing engagement with the outlet and a second position at which it is out of sealing engagement with the valve seat, said valve body being responsive to the level of liquid in the chamber in the chamber and being adapted to close on the liquid level in the chamber exceeding a predetermined level, said valve body having a central passage providing communication to each side of the valve body, a float member supported within the chamber and adapted to cause said movement of said valve body between the first and second position as a result of the presence of liquid in the chamber, the float member being further adapted sealingly engage said central passage as the liquid in the chamber reaches the predetermined level and to and expose said passage on relative movement of the float member away from the valve body.

According to a preferred feature of the invention said valve body when in at it's first position occupies the majority of the available volume in the upper portion of said chamber such that the volume remaining in said upper portion of said chamber represents only a small portion of the total volume of said chamber.

According to a preferred feature of the invention outlet is defined by an aperture having a bore and the valve has a portion which is at least partially received within the bore when the valve body is at its first position said portion supporting a first seal which is adapted to sealingly engage with the bore when the valve body approaches its first position and is at its first position, the valve body having a second seal which is adapted to sealingly close the outlet on the valve body being at its first position.

According to a preferred feature of the invention wherein the first seal comprises a lip-seal.

According to a preferred feature of the invention the first seal comprises a relatively thin, flexible radially disposed seal of larger diameter than the bore of said outlet.

According to a preferred feature of the invention the second seal comprises an O-ring seal.

According to a preferred feature of the invention the float member and the valve body are interconnected to enable some limited movement between the valve body and the float member.

According to a preferred feature of the invention when the central passage has an entry at its lower face which is engaged by a third seal supported by the float member, said entry and third seal being sealingly interengaged when the float member is most proximate the valve body.

According to a preferred feature of the invention wherein the interconnection comprises the third seal.

According to a preferred feature of the invention the entry is formed as a raised annulus extending from the lower face of the valve body.

According to a preferred feature of the invention the third seal comprises a sealing face supported on the upper face of the float member.

According to a preferred feature of the invention the third seal comprises a strip of a flexibly resilient material supported at one end from the float member and at the other end from the valve body and located such that as the float member moves into its most proximate position relative to the valve body it will overlie the entry and as the float member moves away from its most proximate position relative to the valve body it will uncover the entry.

The invention will be more fully understood in light of the following description of several specific embodiments.

### BRIEF DESCRIPTION OF THE DRAWINGS

The description is made with reference to accompanying drawings of which:

FIG. 1 is a sectional elevation of a vent valve according to the first embodiment;

FIG. 2 is a isometric view of the closure plate of the vent valve according to the first embodiment showing the components which are supported from the closure plate;

FIG. 3 is a sectional elevation of the first embodiment illustrating the float and valve body in their lowest position within the chamber;

FIG. 4 is a sectional elevation of the vent valve according to the first embodiment at which the valve body which is initially engaged with the outlet and the float is not at it's uppermost position;

FIG. 5 is a sectional elevation of the first embodiment at which position the valve body is in its fully closed position and the float member is in its uppermost position;

FIG. 6 is a sectional elevation of a vent valve according to the second embodiment;

FIG. 7 is an isometric view of the closure plate of the vent valve according to the third embodiment showing the components which are supported from the closure plate;

FIG. 8 is a side sectional elevation of a vent valve according to the fourth embodiment with the float and valve body in their lowermost positions;

FIG. 9 is a section elevation of the vent valve according to the fourth embodiment with the valve body and float in their uppermost positions.

### DETAILED DESCRIPTION OF SPECIFIC EMBODIMENTS

Each of the embodiments are directed to a vent valve which can be utilised in a fluid line to enable air or gases contained within the fluid line to be vented from the fluid line when the fluid line is pressurised and in use and to enable the entry of air into the fluid line on a low pressure condition being created within the fluid line. The vent valve according to the embodiment has application for use in fluid lines which carry entrained debris and materials such as sewerage.

It is an object of the vent valve according to each of the embodiments to provide an arrangement whereby the sealing between the valve body and the outlet of the vent valve is isolated from the fluid liquid contained within the vent valve and fluid line and any debris entrained therein to reduce the likelihood of the failure of the valve due to any of the entrained debris becoming engaged with the sealing surfaces between the valve body and the outlet.

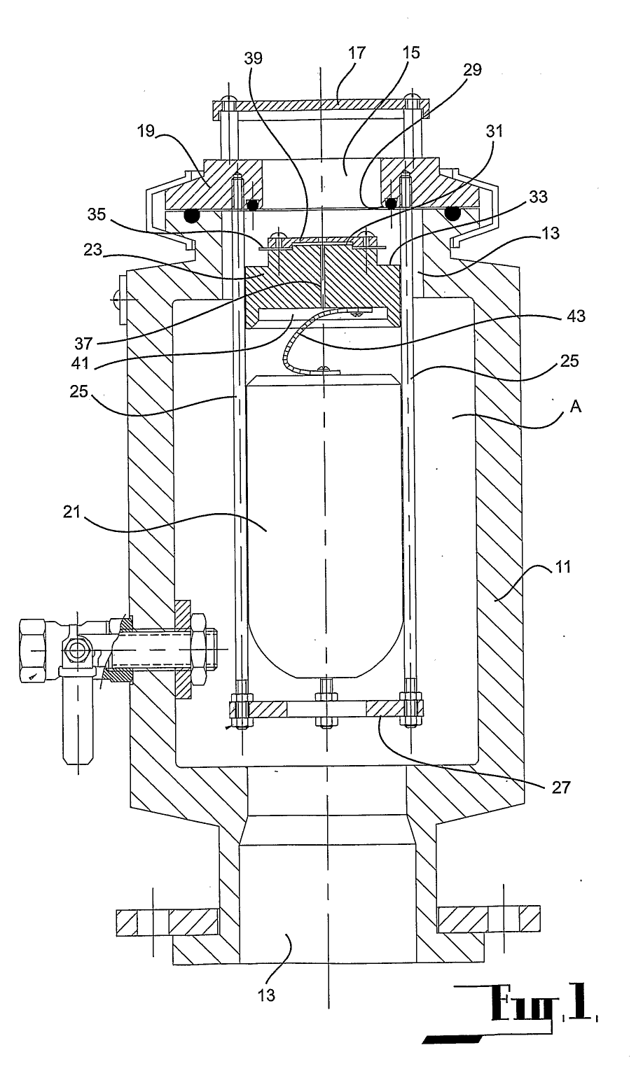

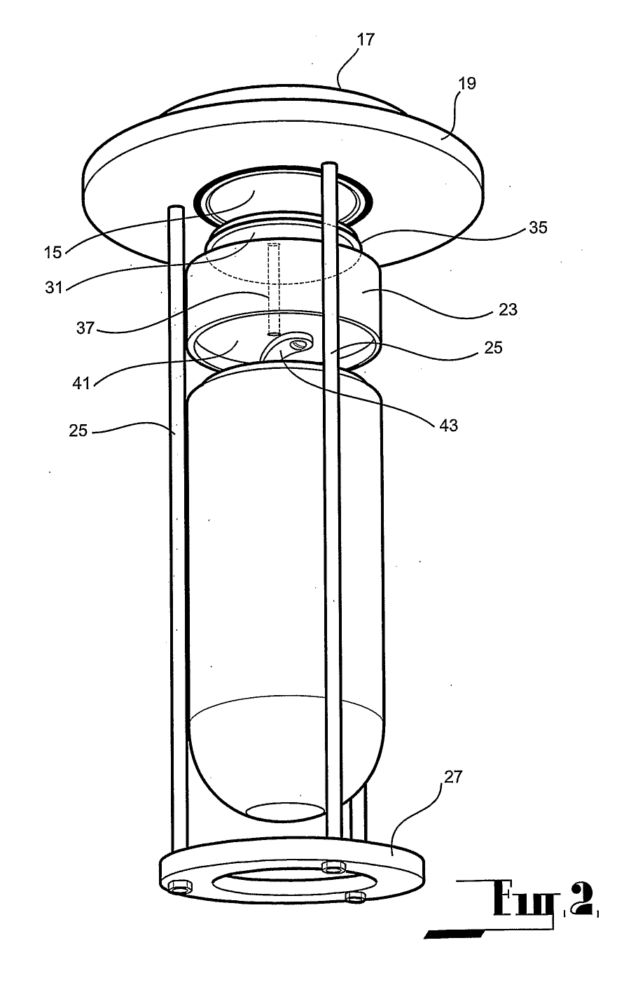

The first embodiment as shown at FIGS. 1 to 5 comprises a vent valve having a body 11 which defines a chamber having a lower portion A and an upper portion B. The lower chamber A has a significant greater volume than the upper chamber B and the upper chamber B is formed to have a reduced diameter when compared to the lower chamber A. The lower end of the lower portion A is provided with a fluid inlet 13 which is intended in use to be connected to a fluid line (not shown), the upper end of the upper chamber B is associated with an outlet 15. The outlet 15 is defined as a circular opening of substantially constant diameter. The inner face of the closure plate 19 is provided with an O-ring seal 29 which is concentric with the outlet 15. The exterior of the outlet 15 is overlaid by baffle plate 17 which is disposed in spaced relation above the outlet 15.

The upper end of the upper end of the chamber is closed by a closure plate 19 which provides the outlet 15. The closure plate 19 supports a float 21 and valve body 23 by means of a set of parallel downwardly depending guide rods 25 which sildably support the float 11 and the valve body 23 to facilitate slidable movement along the longitudinal central axis of the body 11. The lower end of the guide rods 21 are interconnected by a stop member 27 which defines the lowermost position of movement of the float 21 within the body 11 and ensures that the float member, when its lowermost position within the valve body 11, is spaced above the inlet 13.

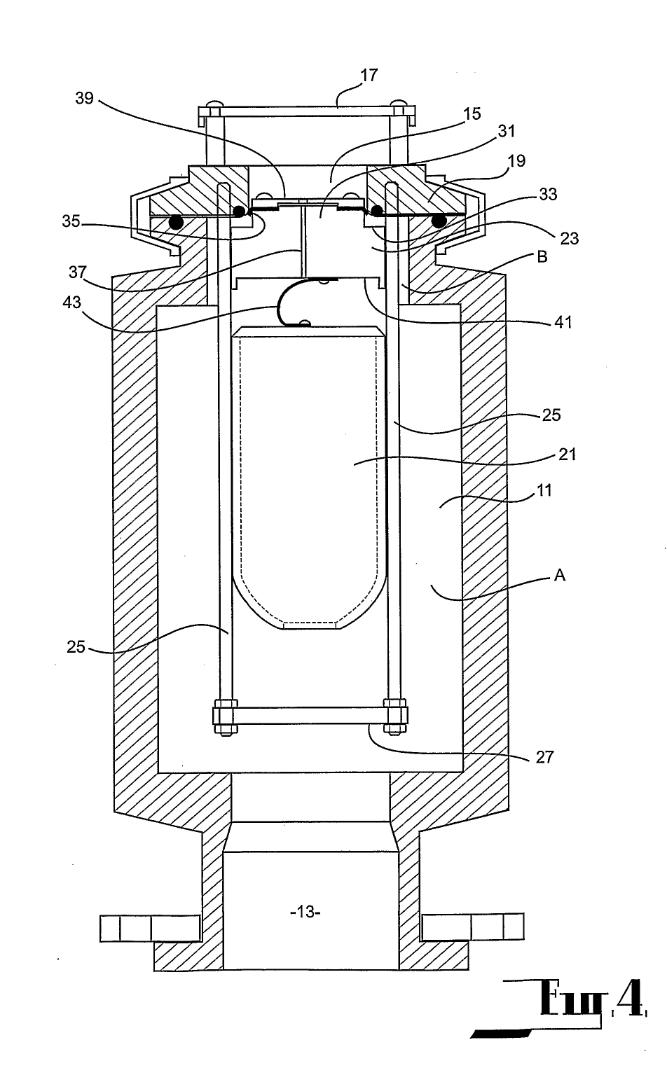

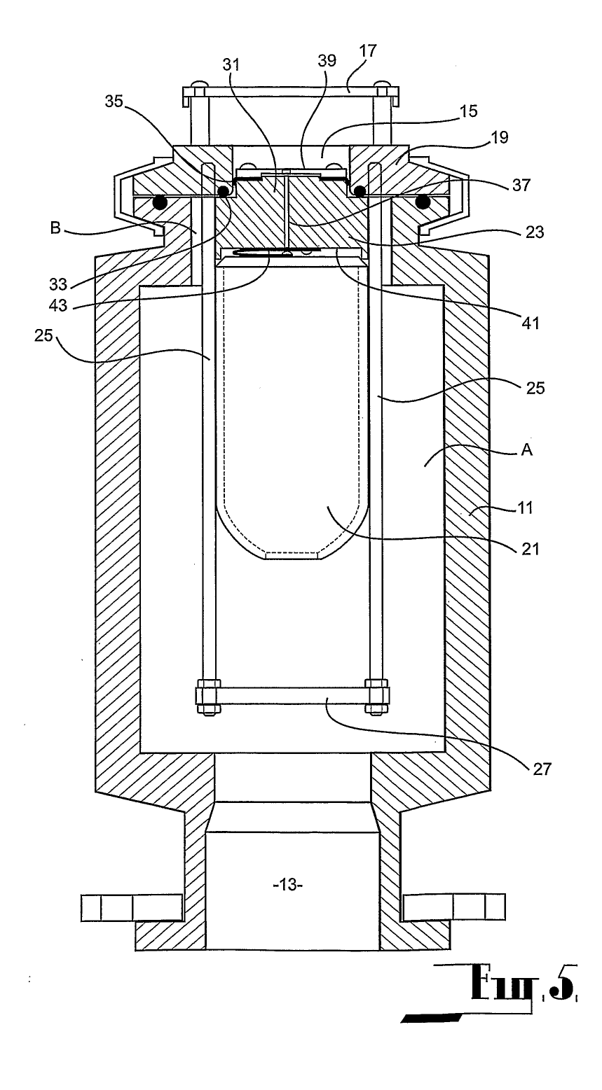

The valve body 23 has a volume such that when it is located in its uppermost position in engagement with the outlet 15 as shown at FIG. 4 it occupies the majority of the volume of the upper chamber B. The upper face of the valve body 23 is formed with a central circular gloss 31 which has a diameter a little less than the diameter of the outlet 15 and which is surrounded by an annular shoulder 33. In use the shoulder is intended to brought into sealing engagement with the O-ring seal 29 surrounding outlet 15. The central boss 31 on the upper face of the valve body 23 supports a lip-seal 35 which is formed of a suitably flexible resilient material such that on engagement of the central boss within the outlet 15 the lip seal 35 will sealingly engage with the side walls of the outlet 15 as shown at FIGS. 4 and 5. The lip-seal 35 comprises a annular washer-like member which is clampingly supported by the central boss 31.

The valve body 23 is also provided with a central passageway 37 which extends between its axial faces 39 and 41.

The float 21 is connected to the lower face 41 of the valve body 23 by a flexible seal 43 which is fixed at its ends to the upper face of the float 21 and the lower face 41 of the valve body 23. The seal is fixed to the lower face 41 of the valve body 23 at a position to one side of the opening of the central passage 37 into the lower face 41. The seal 43 is arranged such that as the float moves towards the valve body the seal will overlie the opening of the passageway 37 to close the passageway and will open the passageway and on movement of the float member away from the valve member 23 in the one face 41.

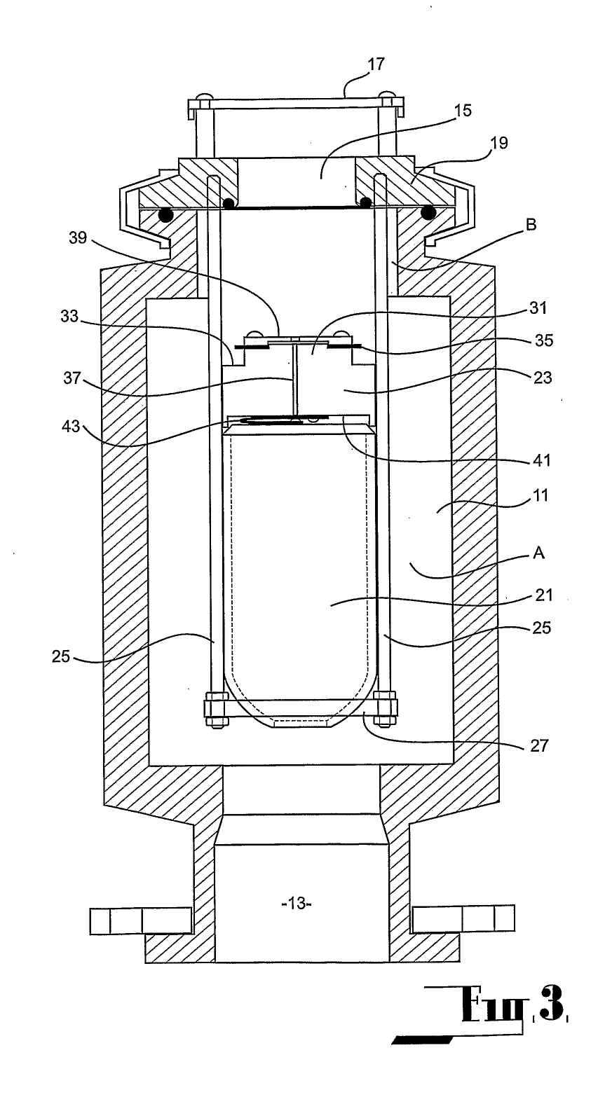

In use when the chamber 11 is empty of liquid. The float 21 will occupy its lowermost position in the body 11 as shown at FIGS. 1 and 3 and the valve body 23 will supported by the upper face of the float 21 as shown at FIG. 3. As liquid enters the body 11 it will fill the lower chamber A and in so doing will cause the float 21 to rise in the lower chamber A and in so doing carry with it the valve body 23 to an initial position as shown at FIG. 4 at which the lip-seal initially engages with the internal bore of the outlet 15. With the further entry of liquid into the lower chamber A the float will engage the lower face of the valve body and lift the valve body into its final sealing position as shown at FIG. 5 at which the shoulder 33 enters into sealing engagement with the O-ring seal 15. With pressurisation of the fluid line with which the valve is associated, the differential pressures between the upper and lower faces 39 and 41 will force the shoulder into sealing engagement with the O-ring seal 29 to ensure sealing engagement of the valve body with the outlet 15. However the initial sealing action by the valve body is effected through the lip seal 35 and is not dependant upon there being sufficient pressure differential between the upper and lower faces of the valve body to facilitate sealing engagement between the shoulder 33 and the O-ring seal.

Once the valve body 23 is in sealing engagement with the outlet 15 by the lip-seal 35 and/or the O-ring seal 29, if the float is caused to move downwardly within the first chamber A as a result of air or gasses entering the chamber A it will move away from the valve body as a result of the lowering of the liquid level. However, because of the pressure differential to either side of the valve body the valve will be maintained in sealing contact with the outlet 15. On sufficient downward movement of the float member relative to the valve body the seal 43 will move form its overlying position over the entry to the passage 37 in the lower face of the valve body. This will permit the controlled escape of the air from the chamber whilst the valve body will be maintained in sealing engagement with the outlet due to the pressure differential which is maintained. On the passage 37 being opened and allowing the escape of the air or gas the float member will rise in the chamber causing the seal 43 to reseal the passage 37.

In the event of the float moving downwardly within the main body to its lowermost position as a result of a falling liquid level within the main chamber A the valve body 23 will be pulled out of engagement with the outlet 15 by the float member due to the interconnection by the seal 43 in two stages, which will comprise firstly the disengagement of the shoulder 33 from the O-ring seal 29 and subsequently the lip-seal 35 moving out of engagement with the bore of the outlet 15.

In circumstances where there is a sudden increase in pressure in the chamber as a result of sudden rising level of liquid in the fluid line, the resultant air flow through the space defined within the upper portion B of the chamber between the valve body 23 and the outlet 15 will create a pressure differential such that the valve body 23 is moved into sealing engagement with the outlet by engagement of the lip-seal 35 with the bore of the outlet 15. This will serve to restrict the flow of air from the vent valve to a flow through the passageway 37 between the lower face 41 and upper face 39 of the valve body 23 which will continue to permit fluid flow from the chamber until such time as the float member has moved upwardly within the chamber to cause the seal to move into apposition at which it overlies the entry to the passage 37 in the lower face 41 of the valve body 23 move into engagement with the valve body 23 and force the shoulder 33 into engagement with the O-ring seal 29.

The formation of the upper portion B of the chamber to have a reduced cross-sectional diameter such that the valve body substantially fills the upper chamber B when in the sealed position ensures that the volume above within the chamber the desired upper-most liquid level is small and for the fluid liquid level within the body to move upwardly beyond its upper-most desired limit will require a fluid line pressure which will be very much greater than any anticipated line pressure for the installation. This reduction in the volume of the available space within the body 11 when the vent valve is fully closed ensures that the liquid level is maintained well below the sealing the surfaces without the necessity to provide significant spacing between the liquid level and anticipated highest liquid level within the body and the sealing surfaces. This enables a valve to be produced which is of a lower height when compared to prior art vent valves.

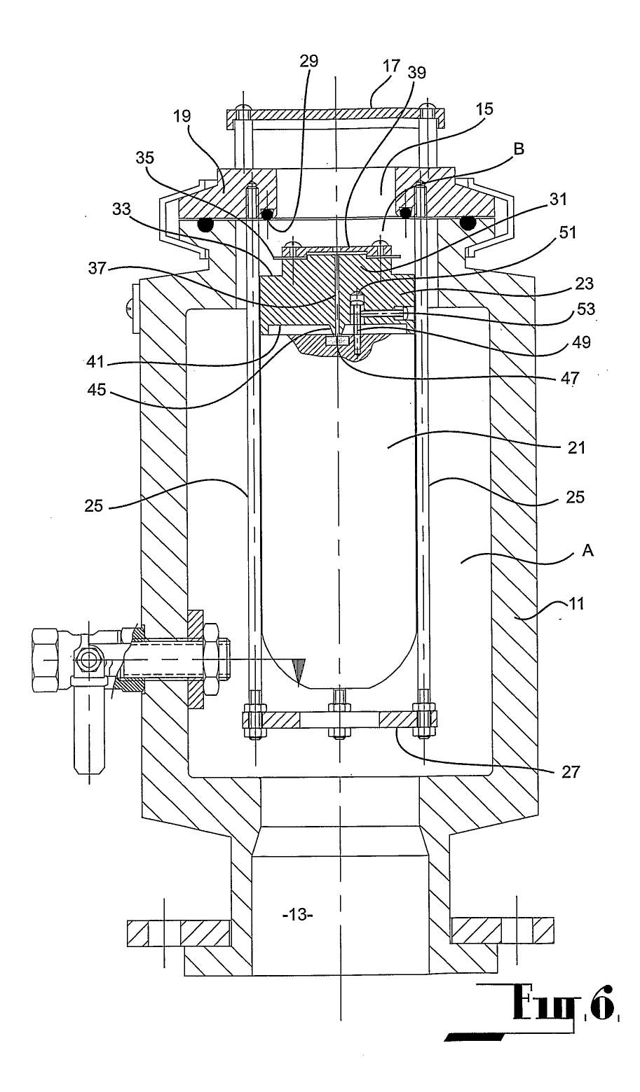

The second embodiment as shown at FIG. 6 is of a generally similar arrangement to that of the first embodiment and therefore corresponding reference numerals will be utilised. The principle difference between the first and second embodiment relates to the nature of interconnection between the valve body 23 and the float 21 and the entry into the passage. In the case of the second embodiment the entry into the central passageway 37 provided at the lower face 41 of the valve body 23 is defined as a central raised annulus 45 and the opposed face of the float member 21 is provided with a sealing face 47 which is formed of a suitable resilient material. In addition, the interconnection between the valve body 23 and the float 21 is effected by means of a upstanding stud 49 which is fixed to the upper face of the float member 21 to extend upwardly therefrom and is formed at its upper end with a enlarged head. The stud is received within a bore 51 provided in the lower face 41 of the valve body 23. The movement of the stud 49 within the bore 51 is controlled by an adjustment screw 53 which is threadably supported with in the valve body 23 and is disposed transverse to the bore 51 to extend into the bore 51 intermediate of its length. The screw 53 which serves to entrap the head of the stud 49 within the bore 51 but to allow for limited axial movement between the valve body 23 and the float 21 between the sealing position as shown at FIG. 6 in an unsealed position at which the head of the stud 49 is engaged with the inner end of the screw 53 and the sealing face 47 on the float 21 is out of engagement with the annulus 45.

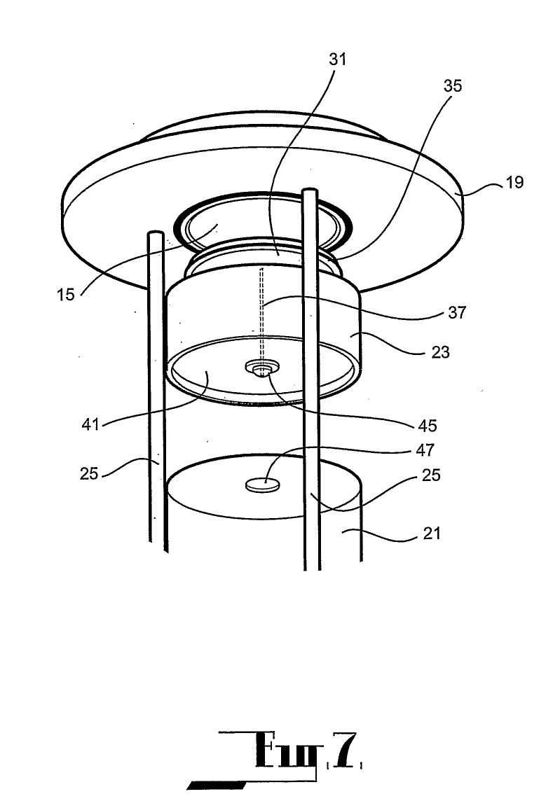

The third embodiment as shown at FIG. 7 generally corresponds with the second embodiment with the exception that there is no interconnection between the float 21 and the valve body 23.

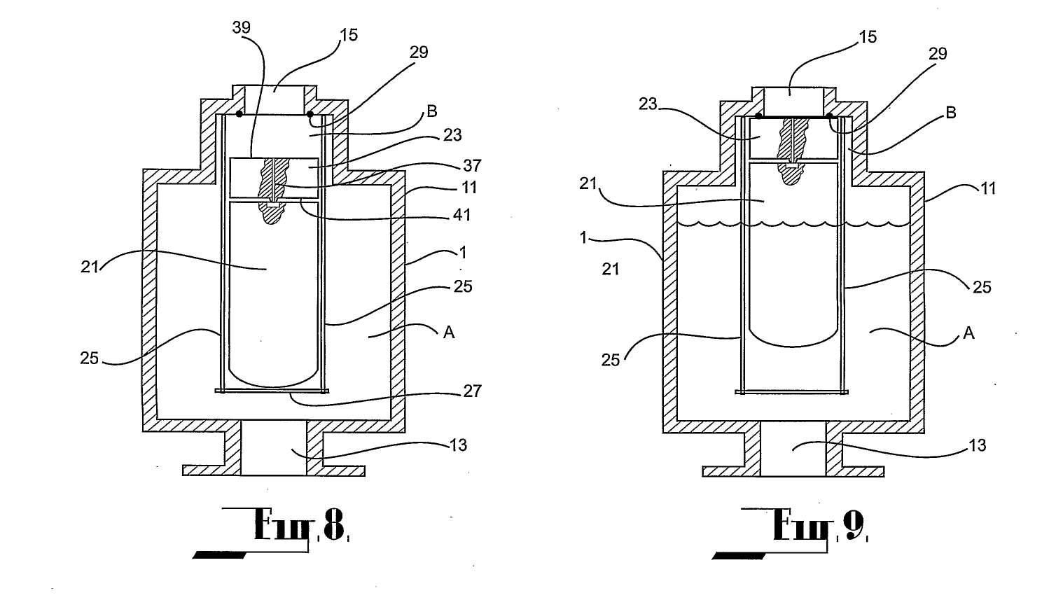

The fourth embodiment which is shown schematically in FIGS. 8 and 9 is of a similar form to the first embodiment with the exception that the upper face of the valve body 23 is not formed with the central boss of the first embodiment and there is a single sealing action between the upper face 39 of the valve body with the O-ring seal 29 which is concentric with the outlet 15. As a result the sealing engagement between the valve body 23 and at the outlet is effected by the O-ring seal only.

Throughout the specification, unless the context requires otherwise, the word “comprise” or variations such as “comprises” or “comprising”, will be understood to imply the inclusion of a stated integer or group of integers but not the exclusion of any other integer or group of integers.

It should be appreciated that the scope of the present invention need not be limited to the particular scope of the embodiments described above.

1. A pipeline vent valve comprising a body defining a chamber of clerestory configuration in which the upper portion of the chamber is of reduced cross-sectional area, the chamber having an inlet towards its lower end which is adapted to be connected to a pipeline and an outlet in the upper portion, a valve body supported in the upper portion of the chamber to be movable between a first position at which it is in sealing engagement with the outlet and a second position at which it is out of sealing engagement with the valve seat, said valve body being responsive to the level of liquid in the chamber in the chamber and being adapted to close on the liquid level in the chamber exceeding a predetermined level, said valve body having a central passage providing communication to each side of the valve body, a float member supported within the chamber and adapted to cause said movement of said valve body between the first and second position as a result of the presence of liquid in the chamber, the float member being further adapted sealingly engage said central passage as the liquid in the chamber reaches the predetermined level and to and expose said passage on relative movement of the float member away from the valve body.

2. A pipeline vent valve as claimed at claim 1 wherein said valve body when in at it's first position occupies the majority of the available volume in the upper portion of said chamber such that the volume remaining in said upper portion of said chamber represents only a small portion of the total volume of said chamber.

3. A pipeline vent valve as claimed at claim 1 or 2 wherein outlet is defined by an aperture having a bore and the valve has a portion which is at least partially received within the bore when the valve body is at its first position said portion supporting a first seal which is adapted to sealingly engage with the bore when the valve body approaches its first position and is at its first position, the valve body having a second seal which is adapted to sealingly close the outlet on the valve body being at its first position.

4. A pipeline vent valve as claimed at claim 3 wherein the first seal comprises a lip-seal.

5. A pipeline vent valve as claimed at claim 3 wherein first seal comprises a relatively thin, flexible radially disposed seal of larger diameter than the bore of said outlet.

6. A pipeline vent valve as claimed at any one of claims 3 or 4 wherein the second seal comprises an O-ring seal.

7. A pipeline vent valve as claimed at any one of the preceding claims wherein the float member and the valve body are interconnected to enable some limited movement between the valve body and the float member.

8. A pipeline vent valve as claimed at any one of the preceding claims wherein when the central passage has an entry at its lower face which is engaged by a third seal supported by the float member, said entry and third seal being sealingly inter-engaged when the float member is most proximate the valve body.

9. A pipeline vent valve as claimed at claim 8 as dependant from claim 7 wherein the interconnection comprises the third seal.

10. A pipeline vent valve as claimed at claim 8 wherein the entry is formed as a raised annulus extending from the lower face of the valve body.

11. A pipeline vent valve as claimed at claim 3 wherein the third seal comprises a sealing face supported on the upper face of the float member.

12. A pipeline vent valve as claimed at claim 8 wherein the third seal comprises a strip of a flexibly resilient material supported at one end from the float member and at the other end from the valve body and located such that as the float member moves into its most proximate position relative to the valve body it will overlie the entry and as the float member moves away from its most proximate position relative to the valve body it will uncover the entry.

13. A pipeline vent valve substantially as herein described ith reference to the accompanying drawings.
